(19) United States
(12) Patent Application Publication
(10) Pub. No.: US 2017/0140326 A1
(43) Pub. Date: May 18, 2017

(54) SERVER AND METHOD FOR PROCESSING DELIVERY INFORMATION AND CHECKING ATTENDANCE

(71) Applicant: Mesh Korea Co., LTD., Seoul (KR)

(72) Inventor: Joung Bum Rhyu, Seoul (KR)

(73) Assignee: Mesh Korea Co., LTD., Seoul (KR)

(21) Appl. No.: 14/764,554

(22) PCT Filed: Jun. 15, 2015
(86) PCT No.: PCT/KR2015/005981

§ 371 Date: Jul. 29, 2015

(51) Int. Cl. G06Q 10/08

(52) U.S. Cl. CPC G06Q 10/083

(57) ABSTRACT

Provided is a server and a method for processing delivery information and verifying an attendance, in which the method includes receiving attribute information about delivery items for which delivery is requested among items registered in a product selling server and location information about a location to which the delivery items are to be delivered, receiving area information about an area in which at least one deliverer delivers the delivery items to a user and load information about a load capacity to perform combined delivery by the at least one deliverer, determining bundled items to be delivered through the combined delivery among the delivery items, an optimal deliverer to deliver the bundled items among the at least one deliverer, and at least one candidate delivery route through which the optimal deliverer delivers the bundled items, based on the attribute information, the location information, the area information, and the load information, and determining an optimal delivery route among the at least one candidate delivery route for the optimal deliverer to perform the combined delivery based on a moving distance and an expected waiting time of the optimal deliverer with respect to the at least one candidate delivery route.

### TECHNICAL FIELD

The present invention relates to a server and a method for processing delivery information and verifying an attendance, and more particularly, to a server and a method for performing combined delivery to deliver a plurality of items together, performing timely delivery to deliver an item at a time requested by a user, and verifying an attendance of a deliverer.

### BACKGROUND ART

The proliferation of information and communication networks and devices has led to various modifications to existing economic activities, and existing methods, targets, and ranges of transactions. For example, due to a development of Internet technology and a proliferation of computers, a transaction method has been changing from a form through which business is transacted between a consumer and a retailer in a real space to a form of an electronic commerce (e-commerce) through which business is transacted in a virtual space on the Internet through Internet media. Due to such a change, a number of requests for delivery services obtained through the e-commerce has been gradually increasing.

Despite a gradual increase in a number of items to be delivered, a number of deliverers delivering the items remains insufficient. In addition, a relatively high cost may be incurred for delivering the items, and a user may not readily predict a delivery time for an ordered item. Further, although the number of deliverers increases as the number of the items to be delivered increases, a system for effectively managing the deliverers has yet to be provided.

### TECHNICAL SOLUTIONS

According to an aspect of the present invention, there is provided a method of processing delivery information, the method including receiving attribute information about delivery items for which delivery is requested among items registered in a product selling server and location information about a location to which the delivery items are to be delivered, receiving area information about an area in which at least one deliverer delivers the delivery items to a user and load information about a load capacity to perform combined delivery by the at least one deliverer, determining bundled items to be delivered through the combined delivery among the delivery items, an optimal deliverer to deliver the bundled items among the at least one deliverer, and at least one candidate delivery route through which the optimal deliverer delivers the bundled items, based on the attribute information, the location information, the area information, and the load information, and determining an optimal delivery route among the at least one candidate delivery route for the optimal deliverer to perform the combined delivery, based on a moving distance and an expected waiting time of the optimal deliverer with respect to the at least one candidate delivery route.

The bundled items may be determined, among the delivery items, not to exceed a weight and a volume capacity of a vehicle of the optimal deliverer.

The bundled items may be determined, among the delivery items, to include a location to which the bundled items are to be delivered in a delivery-available area of the optimal deliverer.

The optimal deliverer may be determined among the at least one deliverer based on at least one of a preparation time for the bundled items, an acceptance location at which the optimal deliver receives the bundled items, an allowable delivery time for the bundled items, and traffic information about traffic during delivery of the bundled items.

The at least one candidate delivery route may be determined based on the acceptance location at which the optimal deliverer receives the bundled items, a location to which the bundled items are to be delivered, and a location of the optimal deliverer.

The attribute information may include information about a weight and a volume of the delivery items, the area information may include information about a preset delivery-available area in which the at least one deliverer delivers a delivery item, and the load information may include information about a weight and a volume capacity of a vehicle of the at least one deliverer.

When desired delivery time information associated with the bundled items is received, the method may further include determining an optimal time for transmitting information about the optimal delivery route to an agent terminal of the optimal deliverer based on the desired delivery time information, the location information, and information about the acceptance location at which the optimal deliverer receives the bundled items, and transmitting the information about the optimal delivery route to the agent terminal at the determined optimal time.

The method may further include determining a moving speed of the at least one deliverer based on location information and time information of the at least one deliverer, comparing the moving speed of the at least one deliverer to a threshold speed used to verify an attendance or an absence of the at least one deliverer, and determining the attendance of the at least one deliverer in response to the moving speed of the at least one deliverer exceeding the threshold speed. The receiving of the area information and the load information may include receiving area information and load information of the at least one deliverer for which attendance is determined.

According to another aspect of the present invention, there is provided a method of processing delivery information performed by a server, the method including receiving, from a product selling server, desired delivery time information associated with a delivery item and location information about a location to which the delivery item is to be delivered, determining an acceptance location at which a deliverer delivering the delivery item to a user receives the delivery item based on the location information, determining an optimal time for transmitting delivery information associated with the delivery item to an agent terminal of the deliverer based on information about the acceptance location, the desired delivery time information, and the location information, and transmitting the delivery information to the agent terminal at the optimal time.

The determining of the optimal time may include determining the optimal time based on at least one of time information about an amount of time used for the deliverer to move to the acceptance location, time information about an amount of time used for the deliverer to move from the acceptance location to the location to which the delivery item is to be delivered, and traffic information about traffic during delivery of the delivery item.

When the delivery item is delivered to the user, the method may further include updating a model for determining the optimal time based on history information associated with delivery of the delivery item, and the determining of the optimal time may be performed using the updated model.

When the delivery item is absent from the acceptance location, the method may further include transmitting, to a service terminal of a product stockroom in which the delivery item is stored, information about the acceptance location so that the delivery item is transferred to the acceptance location before the deliverer arrives at the acceptance location.

The receiving of the desired delivery time information and the location information may include receiving attribute information, desired delivery time information, and location information associated with a plurality of delivery items for which delivery is requested among items registered in the product selling server. Here, the delivery item may be determined to be bundled items to be delivered together through combined delivery among the delivery items. The deliverer may be determined to be an optimal deliverer among at least one deliverer to deliver the bundled items based on area information about an area in which the at least one deliverer delivers a delivery item to the user, load information about a load capacity to perform the combined delivery by the at least one deliverer, the attribute information, the desired delivery time information, and the location information.

The method may further include determining a moving speed of the deliverer based on location information and time information of the deliverer, comparing the moving speed of the deliverer to a threshold speed used to verify an attendance or an absence of the deliverer, and determining the attendance of the deliverer in response to the moving speed of the deliverer exceeding the threshold speed. The transmitting of the delivery information may include transmitting the delivery information to an agent terminal of the deliverer for which attendance is determined.

According to still another aspect of the present invention, there is provided a method of verifying an attendance of a deliverer, the method including verifying location information and time information of a deliverer delivering a delivery item to a user, determining a moving speed of the deliverer based on the location information and the time information, comparing the moving speed of the deliverer to a threshold speed used to verify an attendance or an absence of the deliverer, determining the attendance of the deliverer in response to the moving speed of the deliverer exceeding the threshold speed, and transmitting attendance notification or delivery information to an agent terminal of the deliverer for which attendance is determined.

The method may further include receiving, from the agent terminal, a request for cancellation of the attendance in response to the attendance notification or the delivery information, and cancelling the determined attendance of the deliverer based on the request.

The method may further include receiving attribute information about a plurality of delivery items for which delivery is requested among items registered in a product selling server and location information about a location to which the delivery items are to be delivered, receiving area information about an area in which at least one deliverer delivers the delivery items to the user and load information about a load capacity to perform combined delivery by the at least one deliverer, and determining bundled items to be delivered together through the combined delivery among the delivery items, an optimal deliverer to deliver the bundled items among the at least one deliverer, and an optimal delivery route among at least one candidate delivery route for the optimal deliverer to perform the combined delivery, based on the attribute information, the location information, the area information, and the load information. Here, the at least one deliverer may be a deliverer for which attendance is determined.

When desired delivery time information associated with the delivery item is received, the method may further include determining an optimal time for transmitting the delivery information to the agent terminal based on the desired delivery time information, location information about a location to which the delivery item is to be delivered, and information about an acceptance location at which the deliverer receives the delivery item.

### Effects of Invention

According to example embodiments of the present invention, there is provided a method including determining bundled items to be delivered together among a plurality of delivery items, determining an optimal deliverer to deliver the bundled items, and determining an optimal delivery route through which the optimal deliverer delivers the bundled items, and the method may enable effective delivery of numerous products and effective reduction in costs used for the delivery.

The method may also enable delivery at a time desired by a user and thus, enable a considerable improvement in a satisfaction level of the user using a delivery service.

According to example embodiments of the present invention, there is provided a method including verifying an attendance or an absence of a deliverer delivering an item, and the method may enable effective management of deliverers although a regular attendance time is not set.

### BRIEF DESCRIPTION OF DRAWINGS

These and/or other aspects, features, and advantages of the invention will become apparent and more readily appreciated from the following description of example embodiments, taken in conjunction with the accompanying drawings of which:

FIG. 1 is a diagram illustrating devices performing a method of processing delivery information according to an embodiment of the present invention;

FIG. 1 is a diagram illustrating devices performing a method of processing delivery information according to an embodiment of the present invention;

FIG. 3 illustrates an example process of determining an optimal deliverer to perform combined delivery according to an embodiment of the present invention;

FIGS. 4 through 6 illustrate example processes of determining an optimal delivery route among at least one candidate delivery route through which bundled items are to be delivered according to embodiments of the present invention;

FIG. 7 is a flowchart illustrating a process of transmitting delivery information to deliver an item at a desired delivery time set by a user according to an embodiment of the present invention;

FIG. 8 is a flowchart illustrating a process of delivering an item at a desired delivery time set by a user according to an embodiment of the present invention;

FIG. 9 illustrates an example process of delivering an item at a desired delivery time according to an embodiment of the present invention;

FIG. 10 is a flowchart illustrating a method of verifying an attendance of a deliverer according to an embodiment of the present invention;

FIG. 11 is a flowchart illustrating a process of performing combined delivery based on a desired delivery time set by a user according to an embodiment of the present invention; and

FIG. 12 is a diagram illustrating a configuration of a device performing a method of processing delivery information according to an embodiment of the present invention.

### BEST MODE FOR CARRYING OUT INVENTION

Hereinafter, reference will now be made in detail to embodiments of the present invention, examples of which are illustrated in the accompanying drawings, wherein like reference numerals refer to the like elements throughout.

It will be further understood that the terms “include” and/or “have,” when used in this specification, specify the presence of stated features, integers, steps, operations, elements, components or combinations thereof, but do not preclude the presence or addition of one or more other features, integers, steps, operations, elements, components, and/or groups thereof.

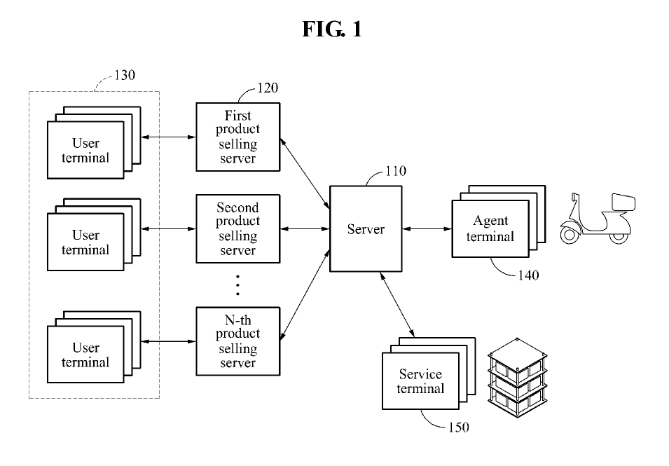

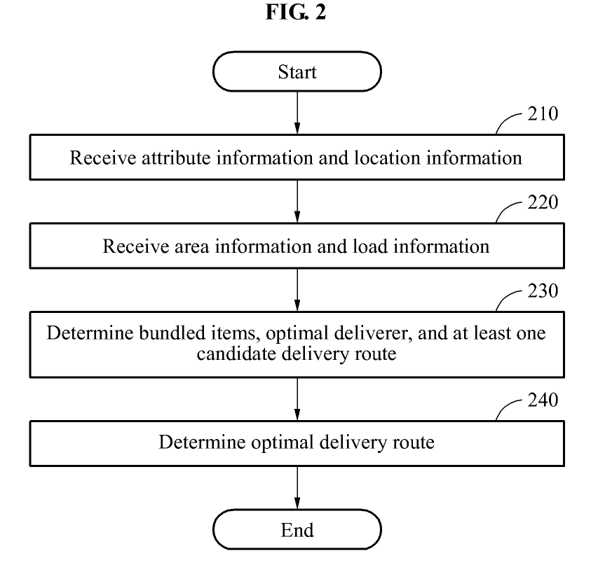

FIG. 1 is a diagram illustrating devices performing a method of processing delivery information, hereinafter referred to as a delivery information processing method, according to an embodiment of the present invention.

Referring to FIG. 1, the devices performing the delivery information processing method include a server 110, a product selling server 120, a user terminal 130, an agent terminal 140, and a service terminal 150.

The server 110 which is a device to process or manage the delivery information may process information associated with delivery requested by a user by communicating with at least one electronic device. The server 110 may receive information associated with a delivery item for which delivery is requested among items registered in the product selling server 120. The server 110 may determine the delivery information based on the information associated with the delivery item, and transmit the delivery information to at least one of the agent terminal 140 and the service terminal 150.

The product selling server 120 may indicate a device configured to provide a list of the registered items to the user terminal 130. The product selling server 120 may receive, from the user terminal 130, order information associated with an item included in the list.

The order information may include at least one of user information and delivery item information. The user information may indicate information about a user and include, for example, user identification information, location information about a location to which an item included in the order information is to be delivered, and user phone number information. The delivery item information may indicate information about a delivery item for which delivery is requested among the registered items in the list. The delivery item may indicate an item for which delivery is requested based on an order made by a user. For example, the delivery item information may include item identification information, item price information, item inventory information, item seller identification information, item seller name information, item seller location information, item seller phone number information, option information, and the like.

The user terminal 130 may indicate a device that may place an order for an item through data communication and include, for example, a smartphone, a tablet computer, a personal digital assistant (PDA), a laptop computer, a desktop computer, a television (TV), and a wearable device. The user terminal 130 may transmit, to the product selling server 120, the order information including a delivery request for at least one of the items registered in the product selling server 120.

The agent terminal 140 may indicate a terminal possessed by a deliverer and receive the delivery information associated with the delivery item through data communication. The agent terminal 140 may include, for example, a smartphone, a tablet computer, a PDA, and a wearable device.

The delivery information may indicate information associated with the delivery item for which delivery is requested by the user terminal 130. For example, the delivery information may include at least one of location information about a location to which the delivery item is to be delivered, information about an acceptance location at which a deliverer receives the delivery item, information about a delivery route, and desired delivery time information associated with the delivery item. The location information may be set by the user terminal 130 and indicate information about a location at which the user desires to receive the delivery item. The information about an acceptance location may indicate information about a location at which a deliverer receives the delivery item to deliver the delivery item to the user, for example, a product store and a product stockroom. The information about a delivery route may indicate information about a route through which a deliverer moves to deliver the delivery item. The desired delivery time information may indicate information about a time at which the user requesting delivery desires to receive the delivery item, and be set by the user terminal 130.

The service terminal 150 may indicate a device provided in a product store or a product stockroom providing an item and include, for example, a smartphone, a tablet computer, a PDA, a laptop computer, a desktop computer, a TV, a wearable device, and a point of sale (POS) terminal. The product store may indicate a store to sell an item to a user, and the product stockroom may indicate a place to store an item, for example, a warehouse and an intermediate station.

The service terminal 150 may transmit, to the server 110, information about an inventory of delivery items in response to a request made by the server 110 for verifying the inventory. The information about the inventory may include information about a number of delivery items in stock at the product store or the product stockroom and information about a preparation time used for preparing each delivery item. The preparation time may be input by a service provider in the product store or the product stockroom, or set for each delivery item. The server 110 receiving the information about the inventory from the service terminal 150 may calculate information about an acceptance location and an acceptance time at which a deliverer receives the delivery item, and transmit the calculated information about the acceptance location and the acceptance time to the agent terminal 140.

FIG. 2 is a flowchart illustrating a process of determining an optimal delivery route for combined delivery according to an embodiment of the present invention.

According to an embodiment, a delivery information processing method including the process of determining an optimal delivery route for combined delivery may be performed by a processor provided in a server.

FIG. 2 assumes a situation in which the combined delivery is performed when a user requests delivery of a plurality of delivery items, or products. Here, bundled items may indicate items to be delivered together through the combined delivery among the plurality of delivery items.

Referring to FIG. 2, in operation 210, the server receives attribute information about the delivery items and location information about a location to which the delivery items are to be delivered. The delivery items may indicate items for which delivery is requested by the user among items registered in a product selling server.

The attribute information may include information about weights and volumes of the delivery items. The attribute information may be input by a service provider in a product store or a product stockroom or preset for each delivery item. The location information may include information about a location at which the user desires to receive a delivery item.

In operation 220, the server receives area information about an area in which at least one deliverer delivers a delivery item and load information about a load capacity to perform the combined delivery by the at least one deliverer.

The area information may include information about a preset delivery-available area in which the at least one deliverer delivers a delivery item. For example, the area information may be set based on an administrative district, or set as a form having a predetermined area size or as an area in a form set by the at least one deliverer.

The load information may include information about a weight and a volume capacity loadable on a vehicle of the at least one deliverer. The vehicle may indicate a mode of transportation used by a deliverer to deliver a delivery item and include, for example, a motorcycle, a light-duty truck, and a heavy-duty truck. The load information may be set based on a vehicle of a deliverer.

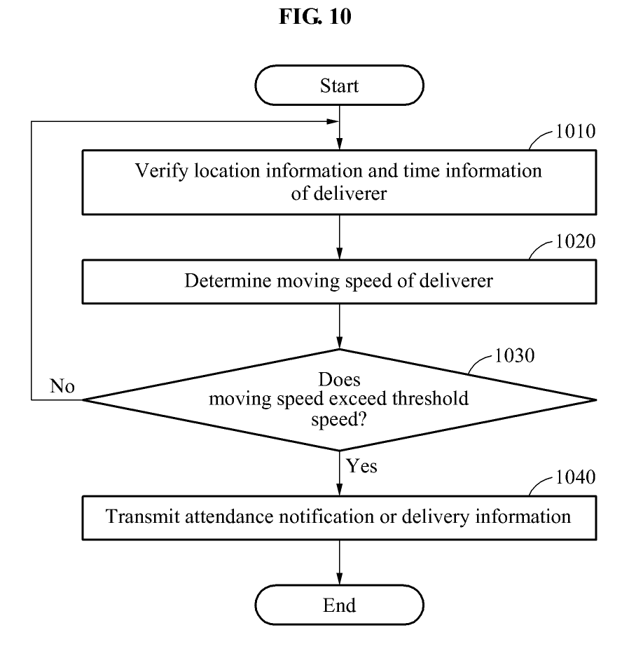

In an example, the server may receive the area information and the load information from an agent terminal of a deliverer. Here, the server may receive area information and load information of a deliverer for which attendance is determined. Alternatively, the server may receive identification information of the deliverer for which attendance is determined and verify the area information and the load information by referring to a database included in the server. A process of determining an attendance of a deliverer will be described with reference to FIG. 10.

In operation 230, the server determines, based on the attribute information, the location information, the area information, and the load information, bundled items to be delivered together among the delivery items, an optimal deliverer to deliver the bundled items among the at least one deliverer, and at least one candidate delivery route through which the optimal deliverer delivers the bundled items.

The server may determine the bundled items among the delivery items not to exceed a weight and a volume capacity of a vehicle of the optimal deliverer. That is, the server may determine the bundled items among the delivery items in order for a weight of the bundled items not to exceed the weight capacity of the vehicle of the optimal deliverer and for a volume of the bundled items not to exceed the volume capacity of the vehicle of the optimal deliverer.

The server may determine the bundled items among the delivery items to include a location to which the bundled items are to be delivered in a delivery-available area of the optimal deliverer. That is, the server may determine, among the delivery items, the bundled items of which a destination location is in the delivery-available area of the optimal deliverer.

The server may determine the optimal deliverer among the at least one deliverer based on at least one of a preparation time for the bundled items, an acceptance location at which the optimal deliverer receives the bundled items, an allowable delivery time for the bundled items, and traffic information about traffic during delivery of the bundled items. The preparation time for the bundled items may indicate an amount of time used for preparing the bundled items in the product store or the product stockroom.

The allowable delivery time may indicate an amount of time used for delivering an item which is generally allowed by a user. The allowable delivery time may be set for each delivery item based on a type of a delivery item. For example, when a delivery item is Italian food to be cooked, an allowable delivery time for the Italian food may be longer than an allowable delivery time for a coffee delivery. The allowable delivery time may be set based on whether a complaint is received from a user who requests delivery. A method disclosed in Korean Patent No. 10-1458723 (registered on Oct. 30, 2014) entitled “Method for Processing Order Information and Apparatus Thereof′ may be applicable to a detailed method of determining the allowable delivery time and thus, a more detailed description will be omitted here.

The server may determine the at least one candidate delivery route based on the acceptance location at which the optimal deliverer receives the bundled items, the location to which the bundled items are to be delivered, and a location of the optimal deliverer. The server may determine the at least one candidate delivery route starting from the location of the optimal deliverer through various combinations of the acceptance location and the location to which the bundled items are to be delivered.

In operation 240, the server determines, among the at least one candidate delivery route, an optimal delivery route for the optimal deliverer to perform the combined delivery based on a moving distance and an expected waiting time of the optimal deliverer with respect to the at least one candidate delivery route. The moving distance may indicate a distance required for the optimal deliverer to move based on each candidate delivery route, and the expected waiting time may indicate an amount of waiting time for receiving the bundled items from the product store or the product stockroom.

The server may calculate an expected level of satisfaction with the at least one candidate delivery route based on the moving distance and the expected waiting time. The expected level of satisfaction may indicate a level of satisfaction of the user when delivery is performed based on the at least one candidate delivery route.

The server may transmit, to an agent terminal of the optimal deliverer, delivery information including information about the bundled items and the optimal delivery route.

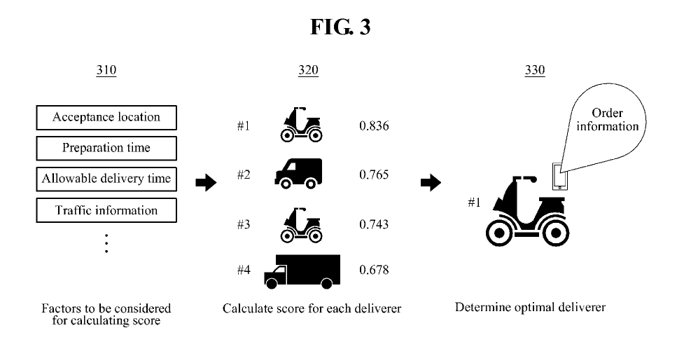

FIG. 3 illustrates an example process of determining an optimal deliverer to perform combined delivery according to an embodiment of the present invention.

According to an embodiment, an optimal deliver to perform combined delivery may be determined among at least one deliverer through the following process.

Referring to FIG. 3, in operation 310, a server selects factors to be considered for calculating a score of each deliverer. For example, the server may select, as the factors, at least one of an acceptance location at which bundled items are received, a preparation time for the bundled items, an allowable delivery time, and traffic information. For another example, the server may select, as the factors, a location of a deliverer, an optimal delivery route, a vehicle of a deliverer, and the like.

In operation 320, the server calculates a respective score of at least one deliverer delivering the bundled items to a user. As illustrated in FIG. 3, a first deliverer whose vehicle is a motorcycle has a highest score among other illustrated deliverers.

In operation 330, the server determines the first deliverer having the highest score to be an optimal deliverer. The server transmits delivery information to an agent terminal of the first deliverer determined to be the optimal deliverer.

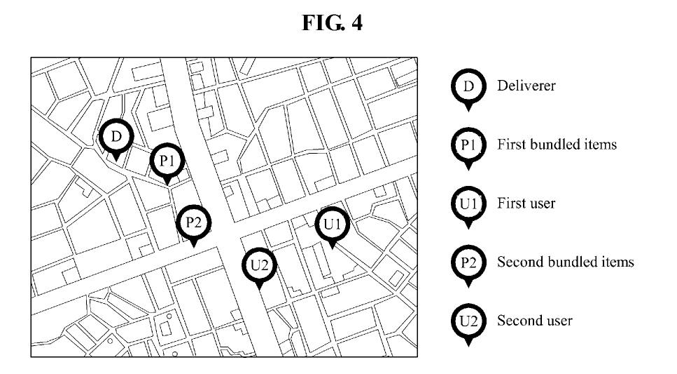

FIGS. 4 through 6 illustrate example processes of determining an optimal delivery route among at least one candidate delivery route through which bundled items are to be delivered according to embodiments of the present invention.

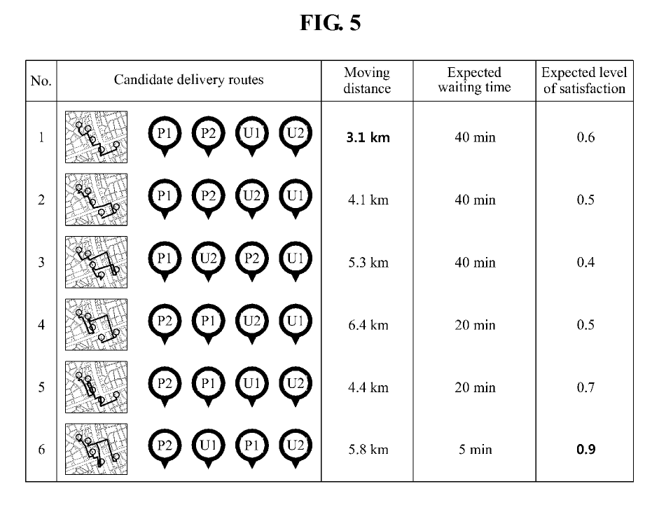

FIGS. 4 and 5 assume a situation in which a deliverer (D) delivers a plurality of bundled items, for example, first bundled items (P1) and second bundled items (P2), to a plurality of users, for example, a first user (U1) and a second user (U2).

Referring to FIG. 4, locations of the D, the P1, the U1, the P2, and the U2 are indicated on a map. Here, the D may indicate a deliverer who delivers the P1 and the P2 to the U1 and the U2, and a deliverer determined to be an optimal deliverer as illustrated in FIG. 3. The P1 may indicate items for which the U1 requests delivery, and the P2 may indicate items for which the U2 requests delivery.

On the map, the location of the P1 may indicate a location at which the D receives the P1, and the location of the P2 may indicate a location at which the D receives the P2. The location of the U1 may indicate a location to which the P1 is to be delivered, and the location of the U2 may indicate a location to which the P2 is to be delivered. That is, the D may deliver the P1 to the U1, and the P2 to the U2.

Referring to FIG. 5, candidate delivery routes determined based on the locations of the D, the P1, the U1, the P2, and the U2 of FIG. 4 are indicated in a table.

The candidate delivery routes may be generated through various combinations of the locations of the P1, the U1, the P2, and the U2. The candidate delivery routes may satisfy the following conditions. The candidate delivery routes may start from the location of the D. The location of the P1 may precede the location of the U1, and the location of the P2 may precede the location of the U2.

Here, a server may calculate expected levels of satisfaction with the candidate delivery routes based on a moving distance and an expected waiting time of the D with respect to the candidate delivery routes.

When a candidate delivery route has a longer expected waiting time despite a shorter moving distance, in comparison to other candidate delivery routes, an expected level of satisfaction with the candidate delivery route may not have a higher value compared to the other candidate delivery routes.

For example, as illustrated in FIG. 5, a first candidate delivery route has a shortest moving distance. However, the first candidate delivery route has a longest expected waiting time based on a time at which the D arrives at an acceptance location and a preparation time for the P1 and the P2. Based on such a moving distance and expected waiting time, the first candidate delivery route may not have a highest expected level of satisfaction. A sixth candidate delivery route does not have a shortest moving distance. However, the sixth candidate delivery route has a shortest expected waiting time based on the time at which the D arrives at the acceptance location and the preparation time for the P1 and the P2. Based on such a moving distance and expected waiting time, the sixth candidate delivery route may have a highest expected level of satisfaction and thus, may be determined to be an optimal delivery route.

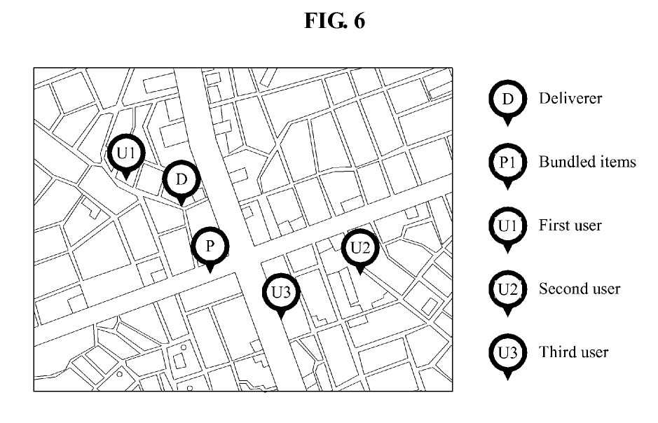

FIG. 6 assumes a situation in which the D delivers bundled items (P) to a plurality of users, for example, the U1, the U2, and a third user (U3).

Referring to FIG. 6, locations of the D, the P, the U1, the U2, and the U3 are indicated on a map. Here, the P may indicate items provided by a same service provider and for which delivery is requested by the U1, the U2, and the U3.

On the map, candidate delivery routes may be generated through various combinations of the locations of the P, the U1, the U2, and the U3. However, the candidate delivery routes may satisfy the following conditions. The candidate delivery routes may start from the location of the D. The location of the P may precede the locations of the U1, the U2, and the U3. A server may calculate an expected level of satisfaction with the candidate delivery routes based on a moving distance and an expected waiting time of the D with respect to the candidate delivery routes. The server may determine, to be an optimal delivery route, a candidate delivery route having a highest expected level of satisfaction among the candidate delivery routes.

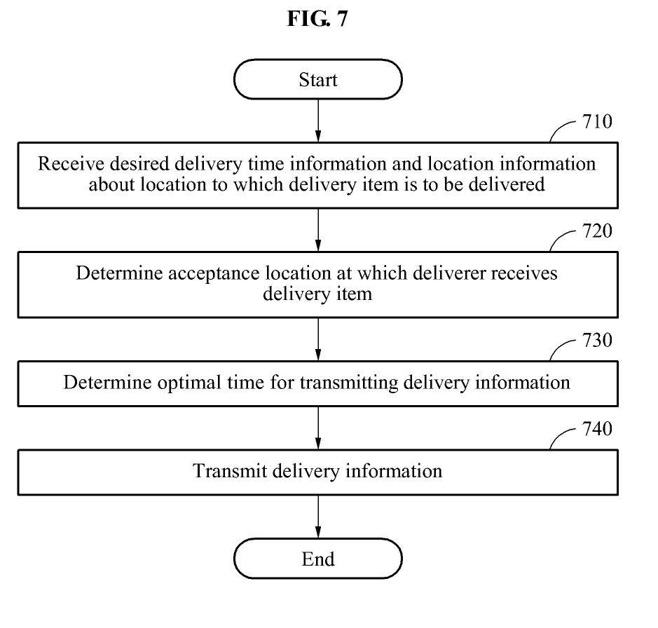

FIG. 7 is a flowchart illustrating a process of transmitting delivery information to deliver an item at a desired delivery time set by a user according to an embodiment of the present invention.

An example of a delivery information processing method including delivering an item at a desired delivery time may be performed by a processor included in a server.

FIG. 7 assumes a situation in which timely delivery is performed when desired delivery time information associated with a delivery item is received from a user.

Referring to FIG. 7, in operation 710, the server receives the desired delivery time information associated with the delivery item and location information about a location to which the delivery item is to be delivered.

In operation 720, the server determines an acceptance location at which a deliverer delivering the delivery item to the user receives the delivery item based on the location information received in operation 710. The acceptance location may indicate a location at which the deliverer receives the delivery item, for example, a product store and a product stockroom.

For example, the server may determine, to be the acceptance location, a location closest to the location to which the delivery item is to be delivered among locations of at least one product store and product stockroom. Alternatively, the server may determine the acceptance location based further on at least one of traffic information and a delivery route from the locations of the at least one product store and product stockroom to the location to which the delivery item is to be delivered. Here, the traffic information may include information about traffic congestion, accidents, limited speeds, and the like on a road ranging from the locations of the at least one product store and product stockroom to the location to which the delivery item is to be delivered and included in the location information. The delivery route may include information about a distance of a route ranging from the locations of the at least one product store and product stockroom to the location to which the delivery item is to be delivered and included in the location information.

In operation 730, the server determines an optimal time for transmitting delivery information associated with the delivery item to an agent terminal of the deliverer based on information on the acceptance location, the desired delivery time information, and the location information. The server may determine the optimal time based further on at least one of time information about an amount of time used for the deliverer to move to the acceptance location, time information about an amount of time used for the deliverer to move from the acceptance location to the location to which the delivery item is to be delivered, and traffic information about traffic during delivery performed by the deliverer.

Thus, the server may control the delivery by determining the optimal time for the deliverer to deliver the delivery item to the user at the desired delivery time. For example, the server may determine, to be the optimal time, a time ahead of the desired delivery time by the amount of time used for the deliverer to move to the acceptance location and the amount of time used for the deliverer to move from the acceptance location to the location to which the delivery item is to be delivered. Here, the server may calculate an amount of time used for the deliverer to move to the acceptance location, from the desired delivery time, using information about a current location of the deliverer and the acceptance location and the traffic information. The server may calculate the amount of time used for the deliverer to move from the acceptance location to the location to which the delivery item is to be delivered using the information about the acceptance location, the location information, and the traffic information.

In operation 740, the server transmits the delivery information to the agent terminal at the optimal time.

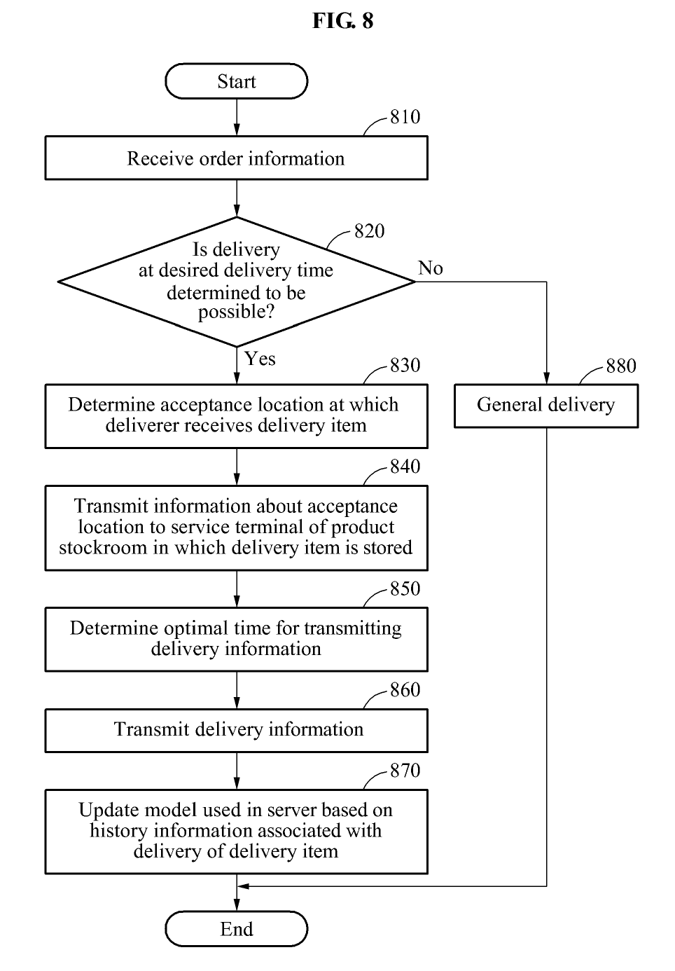

FIG. 8 is a flowchart illustrating a process of delivering an item at a desired delivery time set by a user according to an embodiment of the present invention.

Another example of a delivery information processing method including delivering an item at a desired delivery time may be performed by a processor included in a server.

Referring to FIG. 8, in operation 810, the server receives order information transmitted from a user terminal of a user. The order information may include desired delivery time information in addition to at least one of user information and delivery item information.

In operation 820, the server determines a possibility of delivering a delivery item at the desired delivery time. For example, the server may determine the possibility of delivering the delivery item to a location to which the delivery item is to be delivered at the desired delivery time. Here, the server may determine the possibility of delivering the delivery item at the desired delivery time based on location information about the location to which the delivery item is to be delivered, information about an acceptance location at which a deliverer receives the delivery item, information about a delivery route, and the desired delivery time information associated with the delivery item, which are included in the order information.

In operation 830, when the possibility of delivering the delivery item at the desired delivery time is determined, the server determines the acceptance location at which the deliverer receives the delivery item.

In operation 840, when the delivery item is absent from the determined acceptance location, the server transmits the information about the acceptance location to a service terminal of a product stockroom in which the delivery item is stored. A service provider of the product stockroom may move the delivery item stored in the product stockroom to the acceptance location based on the information about the acceptance location. When the delivery item is present in the determined acceptance location, operation 840 may be omitted.

In operation 850, the server determines an optimal time for transmitting delivery information associated with the delivery item to an agent terminal of the deliverer based on the information about the acceptance location, the desired delivery time information, and the location information.

In operation 860, the server transmits the delivery information to the agent terminal at the optimal time.

In operation 870, when the delivery item is delivered to the user, the server updates a model used in the server based on history information associated with the delivery of the delivery item. The server may make various determinations and decisions using the updated model. For example, the server may determine the optimal time using the updated model. Further, the server may determine the possibility of delivering the delivery item at the desired delivery time or the acceptance location using the updated model.

In operation 880, when the possibility of delivering the delivery item at the desired delivery time is undetermined, that is, when the delivery of the delivery item at the desired delivery time is determined to be impossible, the server transmits, to the user terminal, a message indicating the impossibility of delivering the delivery item at the desired delivery time and allows the delivery item to be delivered through general delivery, for example, overnight or next-day delivery.

The descriptions provided with reference to FIG. 7 may be applicable to the operations described with reference to FIG. 8 and thus, detailed and repeated descriptions will be omitted here for brevity.

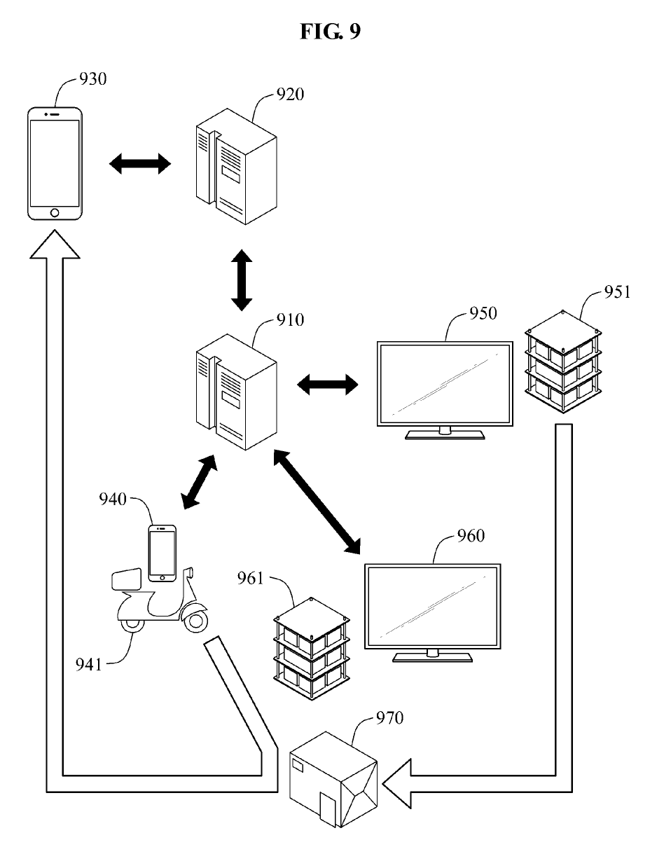

FIG. 9 illustrates an example process of delivering an item at a desired delivery time according to an embodiment of the present invention.

Referring to FIG. 9, devices involved in a delivery information processing method includes a server 910, a product selling server 920, a user terminal 930, an agent terminal 940, a deliverer 941, a first service terminal 950, a warehouse 951, a second service terminal 960, and an intermediate station 961.

The product selling server 920 may provide a list of at least one registered item to the user terminal 930 of a user. The user terminal 930 may transmit, to the product selling server 920, order information associated with a delivery item 970 included in the list. When the user desires same-day delivery, the user terminal 930 may transmit, to the product selling server 920, the order information including information about a request for the same-day delivery. Here, the same-day delivery may indicate delivery through which the delivery item 970 included in the order information is delivered on a same day as when the user terminal 930 transmits the order information.

The product selling server 920 may transmit the order information to the server 910 configured to process delivery information. The server 910 may determine a possibility of same-day delivery to a location to which the delivery item 970 is to be delivered, and transmit a result of the determination to the product selling server 920. When the possibility of the same-day delivery is determined, the server 910 may transmit, to the product selling server 920, information about a detailed delivery-available time slot along with the result of the determination.

When the possibility of the same-day delivery is determined, the product selling server 920 may request desired delivery time information to the user terminal 930. The user terminal 930 may then transmit, to the product selling server 920, the desired delivery time information set in the detailed delivery-available time slot. The product selling server 920 may transmit the desired delivery time information to the server 910.

The server 910 may determine an acceptance location at which the deliverer 940 delivering the delivery item 970 to the user receives the delivery item 970 based on location information included in the order information. For example, when the acceptance location is determined to be the intermediate station 961 by the server 910, the server 910 may transmit information about the acceptance location to the first service terminal 950 of the warehouse 951 in which the delivery item 970 is stored.

The delivery item 970 may be transferred to the intermediate station 961 based on the information about the acceptance location received by the first service terminal 950. When the delivery item 970 is transferred to the intermediate station 961, the second service terminal 960 may transmit, to the server 910, information indicating an arrival of the delivery item 970.

The server 910 may determine an optimal time for transmitting the delivery information associated with the delivery item 970 to the agent terminal 940 based on information on a location of the intermediate station 961, the desired delivery time information, and the location information. The server 910 may transmit the delivery information to the agent terminal 940 at the determined optimal time.

The deliverer 940 may deliver the delivery item 970 which is received at the intermediate station 961 to the user based on the delivery information received by the agent terminal 940.

When the delivery item 970 is delivered to the user, the agent terminal 940 may transmit history information associated with the delivery of the delivery item 970 to the server 910. Here, the history information may indicate a history of processes involved in the delivery of the delivery item 970. For example, the history information may include information about a time at which the deliverer 941 receives the delivery item 970 at the intermediate station 961 and a time at which the deliverer 941 delivers the delivery item 970 to the user.

The server 910 may update a model used in the server 910 based on the history information.

FIG. 10 is a flowchart illustrating a method of verifying an attendance of a deliverer according to an embodiment of the present invention.

The method of verifying an attendance of a deliverer may be processed by a processor included in a server.

Referring to FIG. 10, in operation 1010, the server verifies location information and time information of a deliverer delivering a delivery item to a user. For example, the server may receive the location information and the time information of the deliverer from an agent terminal of the deliverer. In an example, the time information may match the location information indicating a location of the deliverer, and indicate information about a time at the matched location. In another example, when the location information is transmitted to the server on a periodic basis, the time information may include information about the period.

In operation 1020, the server determines a moving speed of the deliverer based on the location information and the time information. The server determines the moving speed of the deliverer by calculating a change in a location based on a time.

In operation 1030, the server determines whether the moving speed exceeds a threshold speed used to verify an attendance or an absence of the deliverer by comparing the moving speed of the deliverer to the threshold speed.

In operation 1040, when the moving speed is determined to exceed the threshold speed, the server transmits attendance notification or delivery information to the agent terminal of the deliverer for which attendance is determined. For example, the agent terminal may display the attendance notification or the delivery information received from the server.

The server may receive, from the agent terminal, a request for cancellation of the attendance in response to the attendance notification or the delivery information. The server may cancel the attendance of the deliverer based on the request for the cancellation.

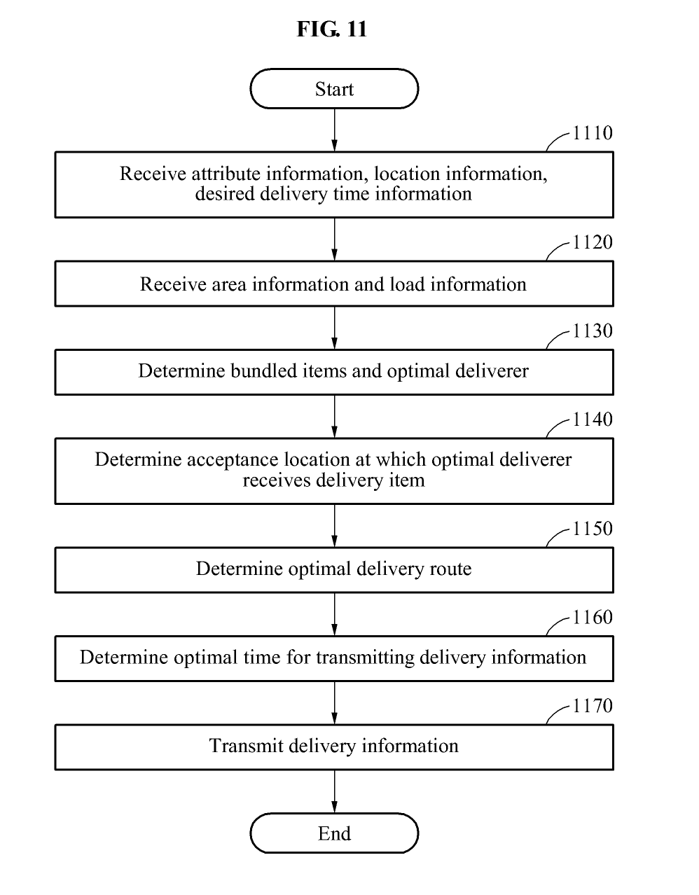

FIG. 11 is a flowchart illustrating a process of performing combined delivery based on a desired delivery time set by a user according to an embodiment of the present invention.

A delivery information processing method including the process of performing combined delivery may be performed by a processor included in a server.

FIG. 11 assumes a situation in which combined delivery and timely delivery are performed when a user requests delivery of a plurality of delivery items, and desired delivery time information associated with the delivery items is received from the user.

Referring to FIG. 11, in operation 1110, the server receives attribute information about the delivery items, location information about a location to which the delivery items are to be delivered, and the desired delivery time information associated with the delivery items.

In operation 1120, the server receives area information about an area in which at least one deliverer delivers a delivery item and load information about a load capacity to perform the combined delivery by the at least one deliverer.

In operation 1130, the server determines bundled items to be delivered together through the combined delivery among the delivery items and an optimal deliverer to deliver the bundled items among the at least one deliverer, based on the attribute information, the location information, the area information, and the load information.

In operation 1140, the server determines an acceptance location at which the optimal deliverer receives the delivery items based on the location information.

In operation 1150, the server determines an optimal delivery route among at least one candidate delivery route through which the optimal deliverer performs the combined delivery based on a moving distance and an expected waiting time of the optimal deliverer with respect to the at least one candidate delivery route.

In operation 1160, the server determines an optimal time for transmitting delivery information associated with the delivery items to an agent terminal of the optimal deliverer based on information about the acceptance location, the desired delivery time information, and the location information.

In operation 1170, the server transmits the delivery information to the agent terminal at the optimal time.

The descriptions provided with reference to FIGS. 1 through 12 may be applicable to the operations described with reference to FIG. 11 and thus, detailed and repeated descriptions will be omitted here for brevity.

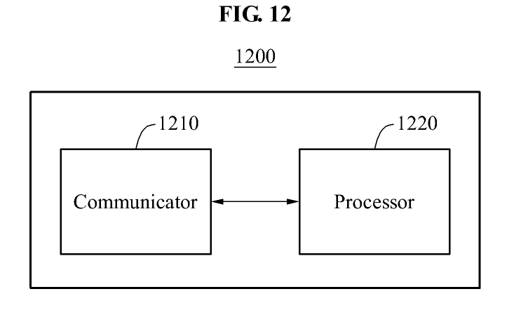

FIG. 12 is a diagram illustrating a configuration of a device performing a delivery information processing method according to an embodiment of the present invention.

Referring to FIG. 12, a server 1200 performing a delivery information processing method includes a communicator 1210 and a processor 1220. The server 1200 illustrated in FIG. 12 is provided as an example and thus, the server 1200 may further include other components or various components may be substituted for the components illustrated in FIG. 12.

The communicator 1210 may communicate with at least one other electronic device. The communicator 1210 may communicate at least one of a user terminal, a product selling server, an agent terminal, and a service terminal.

The communicator 1210 may receive attribute information about a plurality of delivery items for which delivery is requested among items registered in the product selling server, and location information about a location to which the delivery items are to be delivered. The communicator 1210 may receive area information about an area in which at least one deliverer delivers the delivery items to a user, and load information about a load capacity to perform combined delivery by the at least one deliverer.

The processor 1220 may process information associated with delivery based on the information received through the communicator 1210.

The processor 1220 may determine bundled items to be delivered together through the combined delivery among the delivery items, an optimal deliverer to deliver the bundled items among the at least one deliverer, and at least one candidate delivery route through which the optimal deliverer delivers the bundled items, based on the attribute information, the location information, the area information, and the load information. The processor 1220 may determine an optimal delivery route through which the optimal deliverer performs the combined delivery among the at least one candidate delivery route based on a moving distance and an expected waiting time of the optimal deliverer with respect to the at least one candidate delivery route.

Alternatively, the communicator 1210 may receive, from the product selling server, desired delivery time information associated with a delivery item and location information about a location to which the delivery item is to be delivered. The communicator 1210 may transmit, to an agent terminal of a deliverer, delivery information at an optimal time determined by the processor 1220.

The processor 1220 may determine an acceptance location at which the deliverer delivering the delivery item to a user receives the delivery item based on the location information. The processor 1220 may determine the optimal time for transmitting the delivery information associated with the delivery item to the agent terminal of the deliverer based on information about the acceptance location, the desired delivery time information, and the location information.

Alternatively, the communicator 1210 may receive location information and time information of a deliverer delivering a delivery item to a user. The communicator 1210 may transmit attendance notification or delivery information to an agent terminal of a deliverer for which attendance is determined.

The processor 1220 may determine a moving speed of the deliverer based on the location information and the time information, and compare the moving speed of the deliverer to a threshold speed used to verify an attendance or an absence of the deliverer. The processor 1220 may determine the attendance of the deliverer in response to the moving speed of the deliverer exceeding the threshold speed.

The descriptions provided with reference to FIGS. 1 through 11 may be applicable to the operations described with reference to FIG. 12 and thus, detailed and repeated descriptions will be omitted here for brevity.

The above-described example embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

While the present invention includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation.

Therefore, the scope of the present invention is defined not by the detailed description, but by the claims and their equivalents, and all variations within the scope of the claims and their equivalents are to be construed as being included in the disclosure.

1. A method of processing delivery information, comprising:
receiving attribute information about delivery items for which delivery is requested among items registered in a product selling server and location information about a location to which the delivery items are to be delivered;
receiving area information about an area in which at least one deliverer delivers the delivery items to a user and load information about a load capacity to perform combined delivery by the at least one deliverer;
determining bundled items to be delivered through the combined delivery among the delivery items, an optimal deliverer to deliver the bundled items among the at least one deliverer, and at least one candidate delivery route through which the optimal deliverer delivers the bundled items, based on the attribute information, the location information, the area information, and the load information; and
determining an optimal delivery route among the at least one candidate delivery route for the optimal deliverer to perform the combined deliver, based on a moving distance and an expected waiting time of the optimal deliverer with respect to the at least one candidate delivery route.

2. The method of claim 1, wherein the bundled items are determined, among the delivery items, not to exceed a weight and a volume capacity of a vehicle of the optimal deliverer.

3. The method of claim 1, wherein the bundled items are determined, among the delivery items, to comprise a location to which the bundled items are to be delivered in a delivery-available area of the optimal deliverer.

4. The method of claim 1, wherein the optimal deliverer is determined among the at least one deliverer based on at least one of a preparation time for the bundled items, an acceptance location at which the optimal deliver receives the bundled items, an allowable delivery time for the bundled items, and traffic information about traffic during delivery of the bundled items.

5. The method of claim 1, wherein the at least one candidate delivery route is determined based on an acceptance location at which the optimal deliverer receives the bundled items, a location to which the bundled items are to be delivered, and a location of the optimal deliverer.

6. The method of claim 1, wherein the attribute information comprises information about a weight and a volume of the delivery items,
the area information comprises information about a preset delivery-available area in which the at least one deliverer delivers a delivery item, and
the load information comprises information about a weight and a volume capacity of a vehicle of the at least one deliverer.

7. The method of claim 1, further comprising when desired delivery time information associated with the bundled items is received:
determining an optimal time for transmitting information about the optimal delivery route to an agent terminal of the optimal deliverer based on the desired delivery time information, the location information, and information about an acceptance location at which the optimal deliverer receives the bundled items; and
transmitting the information about the optimal delivery route to the agent terminal at the determined optimal time.

8. The method of claim 1, further comprising:
determining a moving speed of the at least one deliverer based on location information and time information of the at least one deliverer;
comparing the moving speed of the at least one deliverer to a threshold speed used to verify an attendance or an absence of the at least one deliverer; and
determining the attendance of the at least one deliverer in response to the moving speed of the at least one deliverer exceeding the threshold speed, and
wherein the receiving of the area information and the load information comprises receiving area information and load information of the at least one deliverer for which attendance is determined.

9. A method of processing delivery information performed by a server, the method comprising:
receiving, from a product selling server, desired delivery time information associated with a delivery item and location information about a location to which the delivery item is to be delivered;
determining an acceptance location at which a deliverer delivering the delivery item to a user receives the delivery item based on the location information;
determining an optimal time for transmitting delivery information associated with the delivery item to an agent terminal of the deliverer based on information about the acceptance location, the desired delivery time information, and the location information; and
transmitting the delivery information to the agent terminal at the optimal time.

10. The method of claim 9, wherein the determining of the optimal time comprises:
determining the optimal time based on at least one of time information about an amount of time used for the deliverer to move to the acceptance location, time information about an amount of time used for the deliverer to move from the acceptance location to the location to which the delivery item is to be delivered, and traffic information about traffic during delivery of the delivery item.

11. The method of claim 9, further comprising when the delivery item is delivered to the user:
updating a model for determining the optimal time based on history information associated with delivery of the delivery item, and
wherein the determining of the optimal time is performed using the updated model.

12. The method of claim 9, further comprising when the delivery item is absent from the acceptance location:
transmitting, to a service terminal of a product stockroom in which the delivery item is stored, information about the acceptance location so that the delivery item is transferred to the acceptance location before the deliverer arrives at the acceptance location.

13. The method of claim 9, wherein the receiving of the desired delivery time information and the location information comprises:
receiving attribute information, desired delivery time information, and location information associated with a plurality of delivery items for which delivery is requested among items registered in the product selling server, and
wherein the delivery item is determined to be bundled items to be delivered together through combined delivery among the delivery items, and
the deliverer is determined to be an optimal deliverer among at least one deliverer to deliver the bundled items based on area information about an area in which the at least one deliverer delivers a delivery item to the user, load information about a load capacity to perform the combined delivery by the at least one deliverer, the attribute information, the desired delivery time information, and the location information.

14. The method of claim 9, further comprising:
determining a moving speed of the deliverer based on location information and time information of the deliverer;
comparing the moving speed of the deliverer to a threshold speed used to verify an attendance or an absence of the deliverer; and
determining the attendance of the deliverer in response to the moving speed of the deliverer exceeding the threshold speed, and
wherein the transmitting of the delivery information comprises transmitting the delivery information to an agent terminal of the deliverer for which attendance is determined.

15. A method of verifying an attendance of a deliverer, the method comprising:
verifying location information and time information of a deliverer delivering a delivery item to a user;
determining a moving speed of the deliverer based on the location information and the time information;
comparing the moving speed of the deliverer to a threshold speed used to verify an attendance or an absence of the deliverer;
determining the attendance of the deliverer in response to the moving speed of the deliverer exceeding the threshold speed; and
transmitting attendance notification or delivery information to an agent terminal of the deliverer for which attendance is determined.

16. The method of claim 15, further comprising:
receiving, from the agent terminal, a request for cancellation of the attendance in response to the attendance notification or the delivery information; and
cancelling the determined attendance of the deliverer based on the request.

17. The method of claim 15, further comprising:
receiving attribute information about a plurality of delivery items for which delivery is requested among items registered in a product selling server and location information about a location to which the delivery items are to be delivered;
receiving area information about an area in which at least one deliverer delivers the delivery items to the user and load information about a load capacity to perform combined delivery by the at least one deliverer; and
determining bundled items to be delivered together through the combined delivery among the delivery items, an optimal deliverer to deliver the bundled items among the at least one deliverer, and an optimal delivery route among at least one candidate delivery route through which the optimal deliverer delivers the bundled items, based on the attribute information, the location information, the area information, and the load information, and
wherein the at least one deliverer is a deliverer for which attendance is determined.

18. The method of claim 15, further comprising when desired delivery time information associated with the delivery item is received:
determining an optimal time for transmitting the delivery information to the agent terminal based on the desired delivery time information, location information about a location to which the delivery item is to be delivered, and information about an acceptance location at which the deliverer receives the delivery item; and
transmitting the delivery information to the agent terminal at the optimal time.
